(19) United States
(12) Patent Application Publication
(10) Pub. No.: US 2017/0250642 A1
(43) Pub. Date: Aug. 31, 2017

(54) Rotation Speed Control Method And Device Of Motor, And Motor Control System

(71) Applicant: BEIJING AEONMED CO., LTD., Beijing (CN)

(72) Inventor: Yajing Fan, Beijing (CN)

(21) Appl. No.: 15/120,921

(22) PCT Filed: Dec. 31, 2014
(86) PCT No.: PCT/CN2014/095779

§ 371 Date: Aug. 23, 2016

(30) Foreign Application Priority Data
Feb. 28, 2014 (CN) 20140073951.1

(51) Int. Cl. H02P 23/00; H02P 6/06

(52) U.S. Cl. CPC H02P 23/0004; H02P 6/06; H02P 2205/07

(57) ABSTRACT

A rotation speed control method and device of a motor, and a motor control system; the rotation speed control method of the motor comprises the following steps: conducting differential regulation on the output rotation speed of the motor to generate a feedback rotation speed signal (S1); generating a rotation speed deviation signal according to a target rotation speed signal and the feedback rotation speed signal (S2); conducting proportional integral regulation on the rotation speed deviation signal to generate a rotation speed control signal (S3); and controlling the rotation speed of the motor according to the rotation speed control signal (S4). The rotation speed control method, the rotation speed control device and the motor control system run steadily and have good dynamic performance, and are easy to implement.

The present invention application claims the priority of Chinese Patent Application No. 201410073951.1, titled “ROTATION SPEED CONTROL METHOD AND DEVICE OF MOTOR, AND MOTOR CONTROL SYSTEM”, filed by Beijing Aeonmed Co., Ltd. on Feb. 28, 2014, which is incorporated herein by reference in its entirety.

### TECHNICAL FIELD

The present invention relates to a technical field of motor, in particular to a method and device for controlling a rotation speed of a motor as well as a system for controlling a motor.

### BACKGROUND OF THE INVENTION

In related technologies, the control modes for rotation speed of a motor mainly comprise PI (Proportional-Integral) control mode and PID (Proportional-Integral-Differential) control mode. Wherein FIG. 1 is a signal flow chart of the PI control mode. As shown in FIG. 1, the working principle of the PI control mode is: a rotation speed deviation signal e′(t) is obtained after a difference of a target rotation speed r′(t) and a feedback rotation speed of the motor y′(t) is taken, and then a proportional-integral regulation is conducted on the rotation speed deviation signal e′(t) to generate a rotation speed control signal u′(t), finally a rotation speed y′(t) of the motor is controlled according to the rotation speed control signal u′(t), thereby realizing the regulation to the rotation speed of the motor.

Furthermore, FIG. 2 is a signal flow chart of the PID control mode. As shown in FIG. 2, the working principle of the PID control mode is: a rotation speed deviation signal e″(t) is obtained after a difference of a target rotation speed r″ (t) and a feedback rotation speed y″(t) of the motor is taken, and then a proportional-integral-differential regulation is conducted on the rotation speed deviation signal e″(t) to generate a rotation speed control signal u″(t), finally a rotation speed y″(t) of the motor is controlled according to the rotation speed control signal u″(t), thereby realizing the regulation to the rotation speed of the motor.

When the rotation speed of the motor is regulated by the above described PI control mode, a rotation speed deviation between an actual rotation speed and a target rotation speed of the motor will be caused suddenly upon the motor suffers a disturbance or a load increases suddenly. Since the PI control mode has no differential regulation segment, the rotation speed deviation appeared or changed suddenly cannot be corrected quickly. However, when the rotation speed of the motor is regulated by the PID control mode, although a differential regulation segment is added, since the differential regulation segment is sensitive to error and noise of an input signal, an abnormal increase of a control variable will be caused once a disturbance appears, which leads to a poor dynamic performance. For example, in actual applications, since the target rotation speed of the motor may often change suddenly, it is easy to cause an oscillation of the overall control system after a differential segment is added. Therefore, the control technology for the rotation speed of the motor in related technologies needs to be improved.

### SUMMARY OF THE INVENTION

The present invention is intended to solve one of the technical problems in the above described related technologies at least to a certain extent.

To this end, an object of the present invention is to provide a method for controlling a rotation speed of a motor which can quickly correct a rotation speed deviation appeared or changed suddenly, and have good dynamic performance.

Another object of the present invention is to provide a device for controlling a rotation speed of a motor.

Still another object of the present invention is to provide a system for controlling a motor.

To achieve the above objects, a method for controlling a rotation speed of a motor proposed by an embodiment of an aspect of the present invention comprises the following steps: conducting a differential regulation on an output rotation speed of the motor to generate a feedback rotation speed signal; generating a rotation speed deviation signal according to a target rotation speed signal and the feedback rotation speed signal; conducting a proportional-integral regulation on the rotation speed deviation signal to generate a rotation speed control signal; and controlling the rotation speed of the motor according to the rotation speed control signal.

The method for controlling a rotation speed of a motor proposed by an embodiment of the present invention generates a feedback rotation speed signal by conducting a differential regulation on an output rotation speed of the motor, and then generates a rotation speed deviation signal according to a target rotation speed signal and the feedback rotation speed signal, and controls the rotation speed of the motor according to a rotation speed control signal after the rotation speed control signal is generated by conducting a proportional-integral regulation on the rotation speed deviation signal. Therefore, the method for controlling a rotation speed a motor of the embodiment of the present invention utilizes the characteristic of a lag of a response of the motor to a command, samples the output rotation speed instead of the rotation speed deviation, not only a rotation speed deviation appeared or changed suddenly can be quickly corrected, but also system oscillation caused by frequent sudden changes of the target rotation speed can be avoided, such that the system runs steadily, has good dynamic performance, and is easy to implement.

Further, in an embodiment of the present invention, the generating a rotation speed deviation signal according to a target rotation speed signal and the feedback rotation speed signal specifically is: taking a difference of the target rotation speed signal and the feedback rotation speed signal to generate the rotation speed deviation signal.

Further, in an embodiment of the present invention, the conducting a proportional-integral regulation on the rotation speed deviation signal to generate a rotation speed control signal specifically comprises: conducting a proportional regulation on the rotation speed deviation signal to generate a proportional control signal; conducting an integral regulation on the rotation speed deviation signal to generate an integral control signal; and superposing the proportional control signal and the integral control signal to generate the rotation speed control signal.

To achieve the above objects, a device for controlling a rotation speed of a motor proposed by an embodiment of another aspect of the present invention comprises: a differential regulating module configured for conducting a differential regulation on an output rotation speed of the motor to generate a feedback rotation speed signal; a rotation speed deviation signal generating module configured for generating a rotation speed deviation signal according to a target rotation speed signal and the feedback rotation speed signal; a rotation speed control signal generating module configured for conducting a proportional-integral regulation on the rotation speed deviation signal to generate a rotation speed control signal; and a control module configured for controlling a rotation speed of the motor according to the rotation speed control signal.

The device for controlling a rotation speed of a motor proposed by an embodiment of the present invention conducts a differential regulation on an output rotation speed of the motor to generate the feedback rotation speed signal by the differential regulating module, and then the rotation speed deviation signal generating module generates a rotation speed deviation signal according to a target rotation speed signal and the feedback rotation speed signal, and after the rotation speed control signal generating module conducts a proportional-integral regulation on the rotation speed deviation signal to generate a rotation speed control signal, finally the control module controls the rotation speed of the motor according to the rotation speed control signal. Therefore, the device for controlling a rotation speed of a motor utilizes the characteristic of a lag of a response of the motor to a command, samples the output rotation speed instead of the rotation speed deviation, not only a rotation speed deviation appeared or changed suddenly can be quickly corrected, but also system oscillation caused by frequent sudden changes of the target rotation speed can be avoided, such that the system runs steadily, has good dynamic performance, and is easy to implement.

Further, in an embodiment of the present invention, the rotation speed deviation signal generating module is specifically configured for taking a difference of the target rotation speed signal and the feedback rotation speed signal to generate the rotation speed deviation signal.

Further, in an embodiment of the present invention, the rotation speed control signal generating module specifically comprises: a proportional regulating unit configured for conducting a proportional regulation on the rotation speed deviation signal to generate a proportional control signal; an integral regulating unit configured for conducting an integral regulation on the rotation speed deviation signal to generate an integral control signal; and a superposing unit configured for superposing the proportional control signal and the integral control signal to generate the rotation speed control signal.

To achieve the above objects, a system for controlling a motor proposed by an embodiment of still another aspect of the present invention comprises the above described device for controlling a rotation speed of a motor.

The system for controlling a motor proposed by an embodiment of the present invention implements a control for the rotation speed of the motor by the above described device for controlling a rotation speed of a motor, utilizes the characteristic of a lag of a response of the motor to a command, samples the output rotation speed instead of the rotation speed deviation, not only a rotation speed deviation appeared or changed suddenly can be quickly corrected, but also system oscillation caused by frequent sudden changes of the target rotation speed can be avoided, such that the system runs steadily and has good dynamic performance.

A part of the additional aspects and advantages of the present invention will be given in the following description, and a part will become obvious from the following description or can be known by the practice of the present invention.

### BRIEF DESCRIPTION OF THE DRAWINGS

The above described and/or additional aspects and advantages of the present invention will become obvious and easy to understand from the description of the embodiments in combination with drawings, wherein:

FIG. 1 is a signal flow chart of a PI control mode;

FIG. 2 is a signal flow chart of a PID control mode;

FIG. 3 is a flow chart of a method for controlling a rotation speed of a motor according to an embodiment of the present invention;

FIG. 4 is a signal flow chart when a method for controlling a rotation speed of a motor according to one embodiment of the present invention controls the motor;

FIG. 5 is a structural block diagram of a device for controlling a rotation speed of a motor according to an embodiment of the present invention; and

FIG. 6 is a structural block diagram of a device for controlling a rotation speed of a motor according to one embodiment of the present invention.

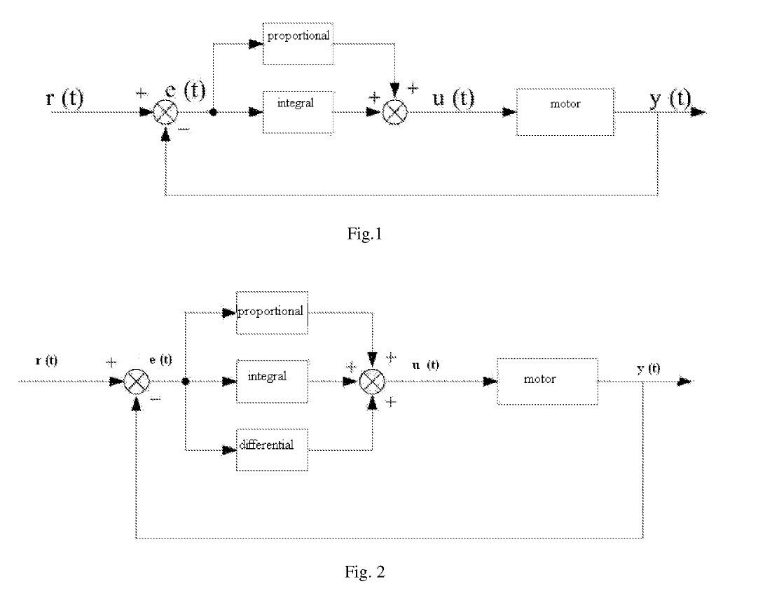

### DETAILED DESCRIPTION OF THE INVENTION

Embodiments of the present invention will be described in detail below, examples of the embodiments are shown in the drawings, wherein same or similar reference numbers represent same or similar elements or elements with same or similar functions throughout the drawings. The embodiments described below with reference to the drawings are merely illustrative, are intended to explain the present invention, and cannot be understood as a limiting to the present invention.

The following disclosure provides plenty of different embodiments or examples to implement different structures of the present invention. In order to simplify the disclosure of the present invention, components and settings of specific examples will be described below. Of course, they are merely illustrative, and not intended to limit the present invention. Furthermore, the present invention may refer to numbers and/or letters repeatedly in different examples. Such repeat is merely for the purpose of simplification and clarity, and does not indicate the relationships between the discussed various embodiments and/or setting in itself. Moreover, the present invention provides examples of various specific processes and materials, but those having ordinary skills in the art can be aware of the applicability of other processes and/or the use of other materials. In addition, a structure of a first feature being “over” a second feature described below can include an embodiment that the first feature and the second feature are formed as a direct contact, and also include an embodiment that an additional feature is formed between the first feature and the second feature, such that the first feature and the second feature may be not in direct contact.

In the description of the present invention, it should be explained that, unless otherwise specified and defined, terms of “mount”, “connected to”, and “connected with” should be understood in a broad sense. For example, the connection may be a mechanical connection or an electrical connection, and may also be a communication inside two elements, may be a direct connection, and may also be an indirect connection via an intermediate. For those having ordinary skills in the art, the specific meanings of the above described terms can be understood according to specific conditions.

A method and device for controlling a rotation speed of a motor as well as a system for controlling a motor according to embodiments of the present invention will be described below with reference to the drawings.

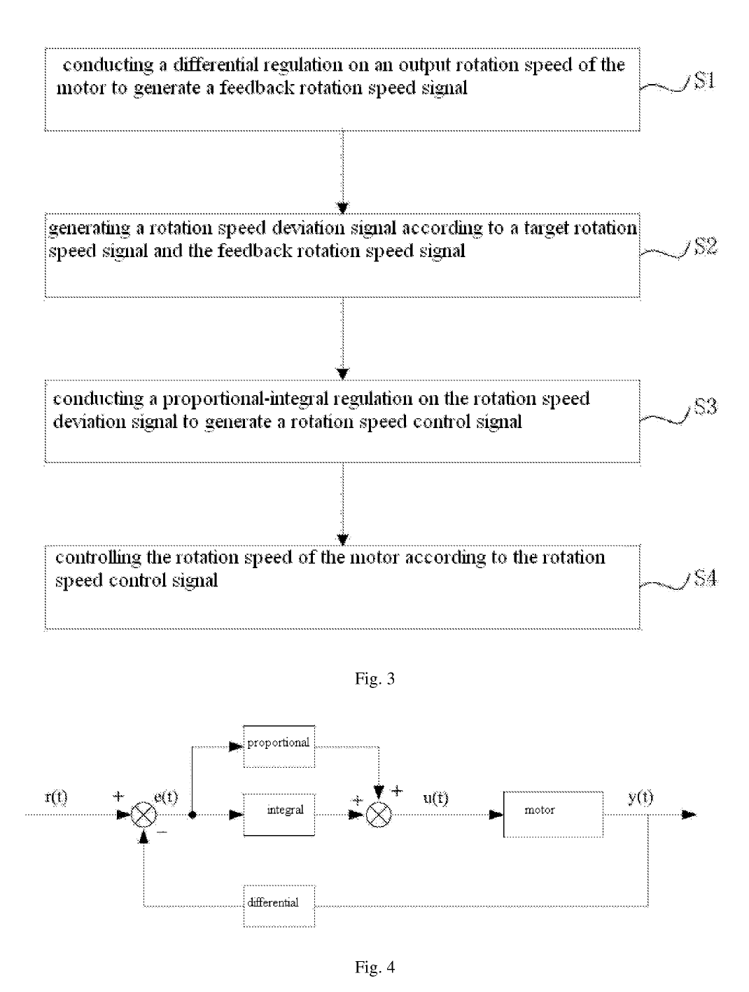

As shown in FIG. 3, a method for controlling a rotation speed of a motor of an embodiment of the present invention comprises the following steps:

S1, conducting a differential regulation on an output rotation speed of the motor to generate a feedback rotation speed signal.

After the feedback rotation speed signal is generated in step S1, the method proceeds to step S2.

S2, generating a rotation speed deviation signal according to a target rotation speed signal and the feedback rotation speed signal.

In an embodiment of the present invention, the generating a rotation speed deviation signal according to a target rotation signal and the feedback rotation speed signal may specifically be: taking a difference of the target rotation speed signal and the feedback rotation speed signal to generate the rotation speed deviation signal.

S3, conducting a proportional-integral regulation on the rotation speed deviation signal to generate a rotation speed control signal.

In an embodiment of the present invention, the conducting a proportional-integral regulation on the rotation speed deviation signal to generate a rotation speed control signal may specifically comprise the following steps:

S31, conducting a proportional regulation on the rotation speed deviation signal to generate a proportional control signal.

S32, conducting an integral regulation on the rotation speed deviation signal to generate an integral control signal.

After generating the proportional control signal and the integral control signal, the method proceeds to step S33.

S33, superposing the proportional control signal and the integral control signal to generate the rotation speed control signal.

After the rotation speed control signal is generated in S3 or S33, the method proceeds to step S4.

S4, controlling the rotation speed of the motor according to the rotation speed control signal.

Further, FIG. 4 is a signal flow chart when a method for controlling a rotation speed of a motor according to one embodiment of the present invention controls the motor. As shown in FIG. 4, when an input target rotation speed signal r(t) of the motor presents a significant change upon, for example, the motor suffers a disturbance or the load increases suddenly, a rotation speed deviation signal e(t) will also present a significant change. However, a response of the motor to a rotation speed control signal u(t) has a lag due to the electrical and mechanical characteristics of the motor, thus an output rotation speed y(t) of the motor will change slowly, and will not change suddenly. Therefore, the method for controlling a rotation speed of a motor of the embodiment of the present invention can avoid effectively an oscillation caused by frequent sudden changes of the target rotation speed signal r(t) of the motor, greatly improving the dynamic performance, the present method works steadily and reliably, and is easy to implement.

The method for controlling a rotation speed of a motor proposed by an embodiment of the present invention generates a feedback rotation speed signal by conducting a differential regulation on an output rotation speed of the motor, and then generates a rotation speed deviation signal according to a target rotation speed signal and the feedback rotation speed signal, and controls the rotation speed of the motor according to a rotation speed control signal after the rotation speed control signal is generated by conducting a proportional-integral regulation on the rotation speed deviation signal. Therefore, the method for controlling a rotation speed a motor of the embodiment of the present invention utilizes the characteristic of a lag of a response of the motor to a command, samples the output rotation speed instead of the rotation speed deviation, not only a rotation speed deviation appeared or changed suddenly can be quickly corrected, but also system oscillation caused by frequent sudden changes of the target rotation speed can be avoided, such that the system runs steadily, has good dynamic performance, and is easy to implement.

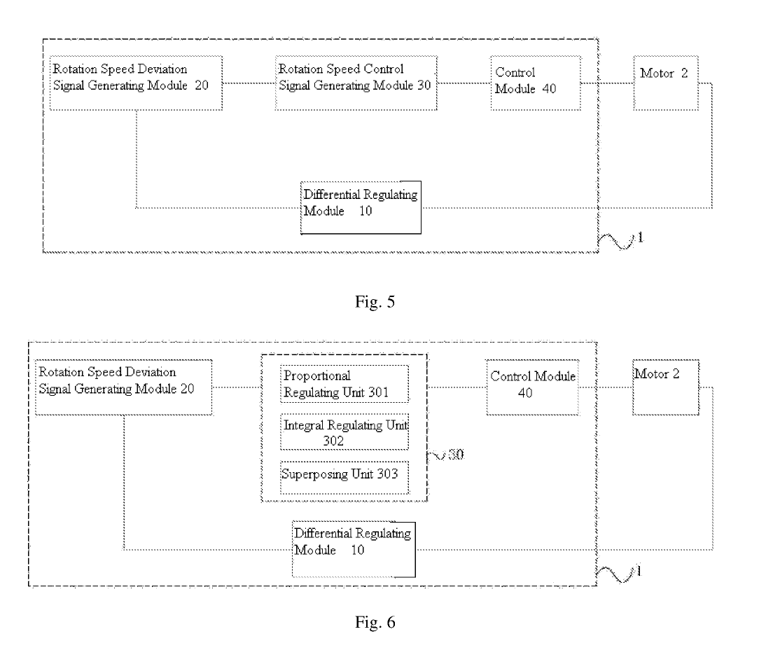

An embodiment of another aspect of the present invention further provides a device for controlling a rotation speed of a motor 1. As shown in FIG. 5, the device for controlling a rotation speed of a motor 1 comprises: a differential regulating module 10, a rotation speed deviation signal generating module 20, a rotation speed control signal generating module 30 and a control module 40. Wherein, the differential regulating module 10 is configured for conducting a differential regulation on an output rotation speed of a motor 2 to generate a feedback rotation speed signal. The rotation speed deviation signal generating module 20 is configured for generating a rotation speed deviation signal according to a target rotation speed signal and the feedback rotation speed signal. The rotation speed control signal generating module 30 is configured for conducting a proportional-integral regulation on the rotation speed deviation signal to generate a rotation speed control signal. The control module 40 is configured for controlling the rotation speed of the motor 2 according to the rotation speed control signal.

In an embodiment of the present invention, the rotation speed deviation signal generating module 20 may take a difference of the target rotation speed signal and the feedback rotation speed signal to generate the rotation speed deviation signal.

Furthermore, in an embodiment of the present invention, as shown in FIG. 6, the rotation speed control signal generating module 30 may specifically comprise: a proportional regulating unit 301, an integral regulating unit 302 and a superposing unit 303. Wherein, the proportional regulating unit 301 is configured for conducting a proportional regulation on the rotation speed deviation signal to generate a proportional control signal. The integral regulating unit 302 is configured for conducting an integral regulation on the rotation speed deviation signal to generate an integral control signal. The superposing unit 303 is configured for superposing the proportional control signal and the integral control signal to generate the rotation speed control signal.

Further, in an embodiment of the present invention, when an input target rotation speed signal of the motor 2 presents a significant change upon for example the motor 2 suffers a disturbance or the load increases suddenly, a rotation speed deviation signal also presents a significant change. However, a response of the motor 2 to a rotation speed control signal has a lag due to the electrical and mechanical characteristics of the motor 2, thus an output rotation speed of the motor 2 will change slowly, and will not change suddenly. Therefore, the device for controlling a rotation speed of a motor 1 of the embodiment of the present invention can avoid effectively an oscillation caused by frequent sudden changes of the target rotation speed signal of the motor 2, greatly improving the dynamic performance, the present device works steadily and reliably, and is easy to implement.

The device for controlling a rotation speed of a motor proposed by an embodiment of the present invention conducts a differential regulation on an output rotation speed of the motor to generate the feedback rotation speed signal by the differential regulating module, and then the rotation speed deviation signal generating module generates a rotation speed deviation signal according to a target rotation speed signal and the feedback rotation speed signal, and after the rotation speed control signal generating module conducts a proportional-integral regulation on the rotation speed deviation signal to generate a rotation speed control signal, finally the control module controls the rotation speed of the motor according to the rotation speed control signal. Therefore, the device for controlling a rotation speed of a motor utilizes the characteristic of a lag of a response of the motor to a command, samples the output rotation speed instead of the rotation speed deviation, not only a rotation speed deviation appeared or changed suddenly can be quickly corrected, but also system oscillation caused by frequent sudden changes of the target rotation speed can be avoided, such that the system runs steadily, has good dynamic performance, and is easy to implement.

In addition, an embodiment of still another aspect of the present invention further provides a system for controlling a motor, the system for controlling a motor comprises the above described device for controlling a rotation speed of a motor 1.

The system for controlling a motor of an embodiment of the present invention implements a control for the rotation speed of the motor by the above described device for controlling a rotation speed of a motor, utilizes the characteristic of a lag of a response of the motor to a command, samples the output rotation speed instead of the rotation speed deviation, not only a rotation speed deviation appeared or changed suddenly can be quickly corrected, but also system oscillation caused by frequent sudden changes of the target rotation speed can be avoided, such that the system runs steadily and has good dynamic performance.

In the description of this specification, the description of reference to terms “an embodiment”, “some embodiments”, “example”, “specific example” or “some examples”, etc. means that a specific feature, structure, material or characteristic described in combination with the embodiment(s) or example(s) is included in at least one embodiment or example of the present invention. In this specification, the schematic expressions of the above described terms are not necessarily to refer to the same embodiment or example. Moreover, the described specific features, structures, materials or characteristics can be combined in any one or more embodiments or examples in a suitable way.

Although the embodiments of the present invention has been shown and described, for those having ordinary skills in the art, it can be understood that, various changes, modifications, replacements and variations can be made to these embodiments without departing from the principle and spirit of the present invention. The scope of the present invention is defined by the appended claims and equivalents thereof.

1. A method for controlling a rotation speed of a motor, comprising the following steps:
conducting a differential regulation on an output rotation speed of the motor to generate a feedback rotation speed signal;
generating a rotation speed deviation signal according to a target rotation speed signal and the feedback rotation speed signal;
conducting a proportional-integral regulation on the rotation speed deviation signal to generate a rotation speed control signal; and
controlling the rotation speed of the motor according to the rotation speed control signal.

2. The method for controlling a rotation speed of claim 1, wherein the generating the rotation speed deviation signal according to the target rotation speed signal and the feedback rotation speed signal comprises:
taking a difference of the target rotation speed signal and the feedback rotation speed signal to generate the rotation speed deviation signal.

3. The method for controlling a rotation speed of claim 1, wherein the conducting the proportional-integral regulation on the rotation speed deviation signal to generate the rotation speed control signal comprises:
conducting a proportional regulation on the rotation speed deviation signal to generate a proportional control signal;
conducting an integral regulation on the rotation speed deviation signal to generate an integral control signal; and
superposing the proportional control signal and the integral control signal to generate the rotation speed control signal.

4. A device for controlling a rotation speed of a motor, comprising:
a differential regulating module configured for conducting a differential regulation on an output rotation speed of the motor to generate a feedback rotation speed signal;
a rotation speed deviation signal generating module configured for generating a rotation speed deviation signal according to a target rotation speed signal and the feedback rotation speed signal;
a rotation speed control signal generating module configured for conducting a proportional-integral regulation on the rotation speed deviation signal to generate a rotation speed control signal; and
a control module configured for controlling the rotation speed of the motor according to the rotation speed control signal.

5. The device for controlling a rotation speed of a motor of claim 4, wherein the rotation speed deviation signal generating module is specifically configured for taking a difference of the target rotation speed signal and the feedback rotation speed signal to generate the rotation speed deviation signal.

6. The device for controlling a rotation speed of a motor of claim 4, wherein the rotation speed control signal generating module specifically comprises:
a proportional regulating unit configured for conducting a proportional regulation on the rotation speed deviation signal to generate a proportional control signal;
an integral regulating unit configured for conducting an integral regulation on the rotation speed deviation signal to generate an integral control signal; and
a superposing unit configured for superposing the proportional control signal and the integral control signal to generate the rotation speed control signal.

7. A system for controlling a motor, comprising:
a differential regulating module configured for conducting a differential regulation on an output rotation speed of the motor to generate a feedback rotation speed signal;
a rotation speed deviation signal generating module configured for generating a rotation speed deviation signal according to a target rotation speed signal and the feedback rotation speed signal;
a rotation speed control signal generating module configured for conducting a proportional-integral regulation on the rotation speed deviation signal to generate a rotation speed control signal; and
a control module configured for controlling a rotation speed of the motor according to the rotation speed control signal.

8. The system for controlling a motor of claim 7, wherein the rotation speed deviation signal generating module is specifically configured for taking a difference of the target rotation speed signal and the feedback rotation speed signal to generate the rotation speed deviation signal.

9. The system for controlling a motor of claim 7, wherein the rotation speed control signal generating module specifically comprises:
a proportional regulating unit configured for conducting a proportional regulation on the rotation speed deviation signal to generate a proportional control signal;
an integral regulating unit configured for conducting an integral regulation on the rotation speed deviation signal to generate an integral control signal; and
a superposing unit configured for superposing the proportional control signal and the integral control signal to generate the rotation speed control signal.
